(19) United States
(12) Patent Application Publication
(10) Pub. No.: US 2009/0168270 A1
(43) Pub. Date: Jul. 2, 2009

(54) EXCHANGE-COUPLED ELEMENT AND MAGNETORESISTANCE EFFECT ELEMENT

(75) Inventors: Migaku Takahashi, Sendai (JP); Masakiyo Tsunoda, Sendai (JP); Koujiro Komagaki, Kawasaki (JP); Yuji Uehara, Kawasaki (JP)

Correspondence Address: GREER, BURNS & CRAIN, 300 S WACKER DR, 25TH FLOOR, CHICAGO, IL, 60606, US

(73) Assignees: FUJITSU LIMITED, Kawasaki-shi (JP); TOHOKU UNIVERSITY, Miyagi (JP)

(21) Appl. No.: 12/342,419

(22) Filed: Dec. 23, 2008

(30) Foreign Application Priority Data
Dec. 28, 2007 (JP) 2007340637

(51) Int. Cl. G11B 5/33

(52) U.S. Cl. 360/324.11; G9B/5.104

(57) ABSTRACT

In comparison with conventional exchange-coupled elements, the exchange-coupled element of the present invention has greater unidirectional magnetization anisotropy. The exchange-coupled element comprises: an ordered antiferromagnetic layer; and a pinned magnetic layer being exchange-coupled with the ordered antiferromagnetic layer, the pinned magnetic layer having unidirectional magnetization anisotropy. The pinned magnetic layer is constituted by a first pinned magnetic layer having a composition, which can have a face-centered cubic lattice structure, and a second pinned magnetic layer having a composition, which can have a body-centered cubic lattice structure.

### BACKGROUND OF THE INVENTION

The present invention relates to an exchange-coupled element and a magnetoresistance effect element, more precisely relates to an exchange-coupled element, in which a pinned magnetic layer is exchange-coupled with an antiferromagnetic layer so as to obtain unidirectional magnetization anisotropy, and a magnetoresistance effect element including the exchange-coupled element.

Magnetoresistance effect elements, in each of which resistance is varied by magnetization signals of a recording medium, have been widely used to read recorded signals from recording media. Each of the magnetoresistance effect elements includes a pinned magnetic layer, whose magnetization direction is fixed, and a free magnetic layer, whose magnetization direction is varied by external magnetic fields. When recorded signals are read from a recording medium, the magnetization direction of the free magnetic layer is varied by magnetization signals from the recording medium. Thus, the recorded signals can be known by detecting resistance variation of the magnetoresistance effect element, which is caused by relative angular difference between the magnetization direction of the free magnetic layer and that of the pinned magnetic layer. The magnetoresistance effect element using this function is called a spin valve element.

Various types of spin valve elements have been provided. Examples of current-in-plane (CIP) type giant magnetoresistance (GMR) elements and current-perpendicular-in-plane (CPP) type tunnel magnetoresistance (TMR) elements will be explained.

An example of the CIP-GMR elements has a following film structure: a lower shielding layer/an insulating layer/a base layer/an antiferromagnetic layer/a first pinned magnetic layer/an antiferromagnetic coupling layer/a second pinned magnetic layer/an intermediate layer/a free magnetic layer/a cap layer/an insulating layer/an upper shielding layer.

On the other hand, an example of the CPP-TMR elements has a following film structure: a lower shielding layer/a base layer/an antiferromagnetic layer/a first pinned magnetic layer/an antiferromagnetic coupling layer/a second pinned magnetic layer/a tunnel barrier layer/a free magnetic layer/a cap layer/an upper shielding layer.

In the CIP-GMR element, a sensing current is passed in the horizontal direction, so the magnetoresistance effect element is electrically insulated from the lower and upper shielding layers. Therefore, the insulating layers are formed on the lower shielding layer and under the upper shielding layer. On the other hand, in the CPP-TMR element, a sensing current is passed perpendicular to the laminated films (layers), so the lower and upper shielding layers act as electrodes and no insulating layers are formed. The base layer is used for growing the antiferromagnetic layer.

In each of the conventional elements, the first pinned magnetic layer is exchange-coupled with the antiferromagnetic layer so as to fix or pin the magnetization direction of the first pinned magnetic layer. Forming the pinned magnetic layer on the antiferromagnetic layer for pinning the magnetization direction of the pinned magnetic layer is publicly known (see Japanese Patent Gazette No. 2004-103806).

By the way, magnetic recording densities of the recording media are increased, so read-elements are highly downsized. By highly downsizing a read-element, a pinned magnetic layer of the read-element will be highly influenced by demagnetizing fields. Namely, a magnetization direction of the pinned magnetic layer, which has been previously perpendicularly pinned with respect to a surface of a recording medium, is rotated by the demagnetizing fields, so that the magnetization direction is inclined with respect to the initial magnetization direction. If the magnetization direction of the pinned magnetic layer is inclined, the magnetization direction will be reversed and characteristics of a magnetic head will be worsened.

To solve the problems of the small element caused by demagnetizing fields, an antiferromagnetic material capable of securely fixing the magnetization direction of the pinned magnetic layer, i.e., antiferromagnetic material having a great unidirectional anisotropy constant Jk (Jk=Ms×d×Hex, wherein Ms is saturated magnetization, d is a film thickness and Hex is a shift magnetic field), is required.

### SUMMARY OF THE INVENTION

The present invention was conceived to solve the above described problems.

An object of the present invention is to provide an exchange-coupled element, whose unidirectional magnetization anisotropy is greater than that of conventional exchange-coupled elements.

Another object is to provide a magnetoresistance effect element including the exchange-coupled element.

Further object is to provide a magnetic storage apparatus including the magnetoresistance effect element.

To achieve the objects, the present invention has following constitutions.

Namely, the exchange-coupled element of the present invention comprises: an ordered antiferromagnetic layer; and a pinned magnetic layer being exchange-coupled with the ordered antiferromagnetic layer, the pinned magnetic layer having unidirectional magnetization anisotropy, wherein the pinned magnetic layer is constituted by a first pinned magnetic layer having a composition, which can have a face-centered cubic lattice structure, and a second pinned magnetic layer having a composition, which can have a body-centered cubic lattice structure.

Preferably, the first pinned magnetic layer contacts the ordered antiferromagnetic layer, and the second pinned magnetic layer is laminated on the first pinned magnetic layer.

Preferably, the ordered antiferromagnetic layer is composed of Mn₃Ir of L12-type ordered alloy.

In the exchange-coupled element, the first pinned magnetic layer may be composed of CoₓFe₁₋ₓ (x=1-0.7), and the second pinned magnetic layer may be composed of CoFe, which can have the body-centered cubic lattice structure. With this structure, the exchange-coupled element can have suitable unidirectional magnetization anisotropy.

Preferably, a thickness of the first pinned magnetic layer is 1 nm or less.

Next, the magnetoresistance effect element of the present invention comprises: an ordered antiferromagnetic layer; a pinned magnetic layer being exchange-coupled with the ordered antiferromagnetic layer, the pinned magnetic layer having unidirectional magnetization anisotropy; a free magnetic layer, in which magnetization is rotated by an external magnetic field; and a nonmagnetic layer being provided between the free magnetic layer and the pinned magnetic layer, and the pinned magnetic layer is constituted by a first pinned magnetic layer having a composition, which can have a face-centered cubic lattice structure, and a second pinned magnetic layer having a composition, which can have a body-centered cubic lattice structure.

Further, the magnetic storage apparatus of the present invention comprises: a head slider having a magnetic head for reading data from a recording medium; a suspension for supporting the head slider over the recording medium; a turnable actuator arm, to which an end of the suspension is fixed; and a receiving circuit for receiving electric signals so as to read the data recorded in the recording medium, the receiving circuit being electrically connected to the magnetic head by insulated cables provided on the suspension and the actuator arm, the magnetic head comprises: an ordered antiferromagnetic layer; a pinned magnetic layer being exchange-coupled with the ordered antiferromagnetic layer, the pinned magnetic layer having unidirectional magnetization anisotropy; a free magnetic layer, in which magnetization is rotated by an external magnetic field; and a nonmagnetic layer being provided between the free magnetic layer and the pinned magnetic layer, and the pinned magnetic layer is constituted by a first pinned magnetic layer having a composition, which can have a face-centered cubic lattice structure, and a second pinned magnetic layer having a composition, which can have a body-centered cubic lattice structure.

By employing the exchange-coupled element of the present invention, the unidirectional magnetization anisotropy greater than that of conventional exchange-coupled elements can be obtained. Therefore, even if the magnetoresistance effect element is highly downsized, the magnetoresistance effect element and the magnetic storage apparatus, which are capable of corresponding to high density recording media, can be realized without deteriorating read-characteristics of the magnetoresistance effect element.

### BRIEF DESCRIPTION OF THE DRAWINGS

Embodiments of the present invention will now be described by way of examples and with reference to the accompanying drawings, in which:

FIG. 1 is an explanation view showing a laminated structure of an embodiment of a magnetoresistance effect element of the present invention;

FIG. 2 is a graph of unidirectional anisotropy constants Jk of exchange-coupled elements with respect to insertion layers;

FIG. 3 is a graph of unidirectional anisotropy constants Jk of exchange-coupled elements with respect to thicknesses of insertion layers, wherein each of the exchange-coupled elements includes an antiferromagnetic layer composed of ordered Mn₃Ir and the insertion layer composed of Co₉₀Fe₁₀;

FIG. 4 is a graph of unidirectional anisotropy constants Jk of exchange-coupled elements, in each of which a pinned magnetic layer is formed on a disordered antiferromagnetic layer;

FIG. 5 is a graph showing a relationship between compositions of Fe in CoFe alloys and crystal structures; and

FIG. 6 is a plan view of a magnetic storage apparatus.

### DETAILED DESCRIPTION OF THE EMBODIMENTS

Preferred embodiments of the present invention will now be described in detail with reference to the accompanying drawings.

### (Magnetoresistance Effect Element)

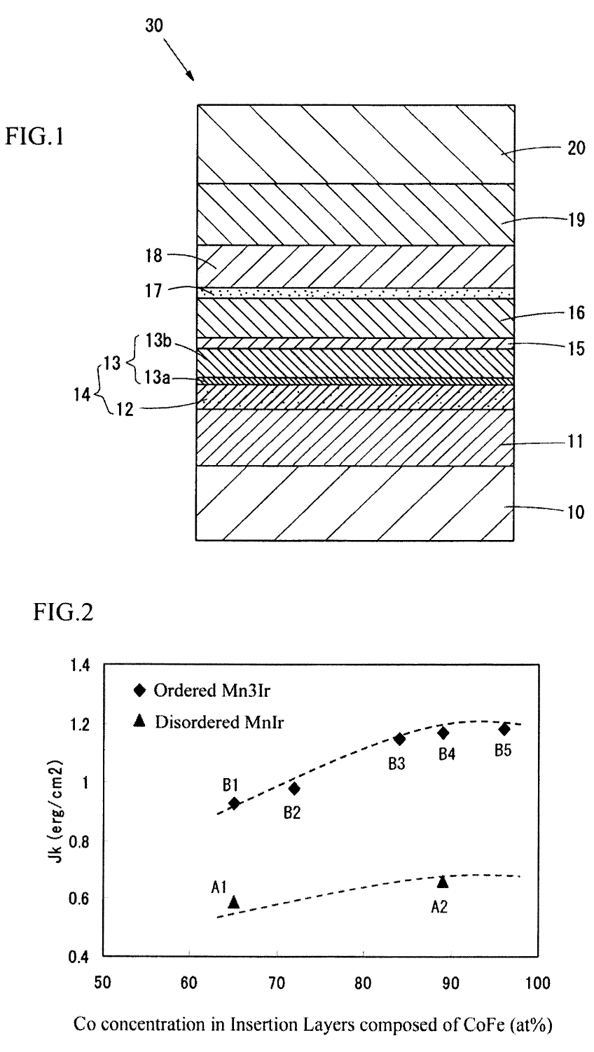

FIG. 1 shows a CPP-TMR element 30, which is an embodiment of a magnetoresistance effect element including an exchange-coupled element of the present invention.

The magnetoresistance effect element 30 comprises: a lower shielding layer 10; a base layer 11; an antiferromagnetic layer 12; a first pinned magnetic layer 13a; a second pinned magnetic layer 13b; an antiferromagnetic coupling layer 15; a third pinned magnetic layer 16; a nonmagnetic tunnel barrier layer 17; a free magnetic layer 18; a cap layer 19 and an upper shielding layer 20. The layers are laminated in that order.

The magnetoresistance effect element 30 is characterized by an exchange-coupled element 14, which comprises the antiferromagnetic layer 12 and a pinned magnetic layer 13 constituted by the first pinned magnetic layer 13a and the second pinned magnetic layer 13b. Note that, in the following description, the laminated structure including the antiferromagnetic layer 12 and the pinned magnetic layer 13 is called the exchange-coupled element 14.

The structure in which an antiferromagnetic layer and a pinned magnetic layer are laminated to fix or pin a magnetization direction of the pinned magnetic layer by exchange-coupling function is widely used in conventional magnetoresistance effect elements.

The exchange-coupled element 14 of the present embodiment is characterized in that the pinned magnetic layer 13 formed on the antiferromagnetic layer 12 is constituted by the first pinned magnetic layer 13a and the second pinned magnetic layer 13b, that the first pinned magnetic layer 13a is a magnetic layer having a composition, whose crystal structure can be a face-centered cubic lattice structure (fcc), and that the second pinned magnetic layer 13b is a magnetic layer having a composition, whose crystal structure can be a body-centered cubic lattice structure (bcc).

The first pinned magnetic layer 13a and the second pinned magnetic layer 13b, which constitute the pinned magnetic layer 13, are composed of, for example, CoFe alloys. It is known that the crystal structure of the CoFe alloy is the body-centered cubic lattice structure when the composition is Co₆₅Fe₃₅, and that the crystal structure of the CoFe alloy is the face-centered cubic lattice structure when concentration of Co is 70 at. % or more, e.g., Co₇₀Fe₃₀, Co₈₅Fe₁₅.

Therefore, the pinned magnetic layer 13 of the exchange-coupled element 14 can be constituted by, for example, the first pinned magnetic layer 13a composed of Co₇₀Fe₃₀ and the second pinned magnetic layer 13b composed of Co₆₅Fe₃₅.

Further, the exchange-coupled element 14 of the present embodiment is characterized in that the antiferromagnetic layer 12 is composed of an ordered antiferromagnetic material.

MnIr has been known as an antiferromagnetic material of the antiferromagnetic layer 12 of the magnetoresistance effect element. MnIr alloys are divided into ordered ones and disordered ones on the basis of their crystal structures. In case that Mn atoms and Ir atoms are randomly arranged, the disordered MnIr is produced; in case that Mn atoms are located at face centers and Ir atoms are located at apexes of unit lattices, the ordered MnIr (L12-type ordered alloy) is produced.

In the exchange-coupled element 14 of the present embodiment, the antiferromagnetic layer 12 may be composed of the ordered antiferromagnetic material, e.g., Mn₃Ir of L12-type ordered alloy.

Namely, in the exchange-coupled element 14, the first pinned magnetic layer 13a having the composition, which can have the face-centered cubic lattice structure, and the second pinned magnetic layer 13b having the composition, which can have the body-centered cubic lattice structure, are laminated on the antiferromagnetic layer 12, which is composed of Mn₃Ir of L12-type ordered alloy.

In the magnetoresistance effect element 30, the antiferromagnetic layer 15 is laminated on the second pinned magnetic layer 13b, and the third pinned magnetic layer 16 is further laminated. The antiferromagnetic coupling layer 15 and the third pinned magnetic layer 16 stabilize the magnetization direction of the entire pinned magnetic layer and tightly fix the magnetization direction thereof. By including the antiferromagnetic layer in the pinned magnetic layer, the magnetization direction can be tightly fixed.

The magnetic layers, etc. of the magnetoresistance effect element may be composed of various materials. For example, the magnetoresistance effect element 30 shown in FIG. 1 comprises: the lower shielding layer 10 composed of NiFe; the base layer 11 composed of Ta layer and Ru layer and having a thickness of 3 nm; the antiferromagnetic layer 12 composed of Mn₃Ir and having a thickness of 1 nm; the first pinned magnetic layer 13a composed of Co₈₅Fe₁₅ and having a thickness of 1 nm; the second pinned magnetic layer 13b composed of Co₆₅Fe₃₅ and having a thickness of 2 nm; the antiferromagnetic coupling layer 15 composed of Ru and having a thickness of 1 nm; the third pinned magnetic layer 16 composed of CoFeB and having a thickness of 3 nm; the tunnel barrier layer 17 composed of MgO having a thickness of 1 nm; the free magnetic layer 18 composed of CoFe or CoFeB and having a thickness of 3 nm; the cap layer 19 composed of Ta or Ru and having a thickness of 5 nm; and the upper shielding layer 20 composed of NiFe.

FIG. 2 is a graph of unidirectional anisotropy constants Jk of exchange-coupled elements, each of which includes the antiferromagnetic layer and the pinned magnetic layer, with respect to pinned magnetic layers.

Disordered MnIr and ordered Mn₃Ir are used as antiferromagnetic materials of antiferromagnetic layers. A CoFe layer, whose composition can have the face-centered cubic lattice structure, and a Co₆₅Fe₃₅ layer, whose composition can have the body-centered cubic lattice structure, are laminated on each of the antiferromagnetic layers, in this order, to form a pinned magnetic layer. The unidirectional anisotropy constants Jk of the three-layered laminated films (pinned magnetic layers) measured are shown in FIG. 2. Thicknesses of the disordered MnIr layer and the ordered Mn₃Ir layer are 10 nm; a thickness of the lower CoFe layer (insertion layer) having the composition, which can have the face-centered cubic lattice structure, is 0.5 nm; and a thickness of the upper Co₆₅Fe₃₅ layer having the composition, which can have the body-centered cubic lattice structure, is 4 nm.

In the graph of FIG. 2, a measured datum A1 relates to a structure in which the Co₆₅Fe₃₅ layer is laminated on the disordered MnIr layer as the insertion layer and the upper Co₆₅Fe₃₅ layer is laminated on the insertion layer; a measured datum B1 relates to a structure in which the Co₆₅Fe₃₅ layer is laminated on the ordered Mn₃Ir layer as the insertion layer and the upper Co₆₅Fe₃₅ layer is laminated on the insertion layer. By using the Co₆₅Fe₃₅ layers as the insertion layers, the lower and upper CoFe layers are composed of the same material, i.e., Co₆₅Fe₃₅, so that the structure is the same as that of the conventional exchange-coupled element, in which the pinned magnetic layer is laminated on the antiferromagnetic layer.

The graph of FIG. 2 shows variations of the unidirectional anisotropy constants Jk of the exchange-coupled elements with respect to insertion layers, each of which is the CoFe layer, whose composition can have the face-centered cubic lattice structure, and inserted between the antiferromagnetic layer and the upper Co₆₅Fe₃₅ layer of the conventional exchange-coupled element.

As described above, a measured datum A2 relates to a structure in which the Co₉₀Fe₁₀ layer is laminated on the disordered MnIr layer as the insertion layer and the upper Co₆₅Fe₃₅ layer is laminated on the insertion layer. In comparison with the conventional structure (the datum A1), the unidirectional anisotropy constant Jk of the this exchange-coupled element is slightly improved, but characteristics are not sufficiently improved.

On the other hand, in case of laminating the CoFe insertion layers on the ordered Mn₃Ir layers, the unidirectional anisotropy constants Jk of a datum B2, in which a Co₇₀Fe₃₀ layer is laminated on the ordered Mn₃Ir layer as the insertion layer, a datum B3, in which a Co₈₅Fe₁₅ layer is laminated as the insertion layer, a datum B4, in which a Co₉₀Fe₁₀ layer is laminated as the insertion layer, and a datum B5, in which a Co₉₅Fe₅ layer is laminated as the insertion layer, are highly superior to that of a conventional structure (a datum B1).

As described above, Co₇₀Fe₃₀, Co₈₅Fe₁₅, Co₉₀Fe₁₀ and Co₉₅Fe₅ originally have the face-centered cubic lattice structures. According to the graph of FIG. 2, the unidirectional anisotropy constant Jk of the exchange-coupled element can be improved by inserting the CoFe layer, whose composition can have the face-centered cubic lattice structure, between the antiferromagnetic layer and the Co₆₅Fe₃₅ layer, whose composition can have the body-centered cubic lattice structure, as the insertion layer.

In comparison with the structure in which the disordered MnIr layer is used as the antiferromagnetic layer, the antiferromagnetic layer composed of the ordered Mn₃Ir can increase the unidirectional anisotropy constant Jk more than double. Therefore, the exchange-coupled element having the antiferromagnetic layer composed of the ordered Mn₃Ir has superior characteristics.

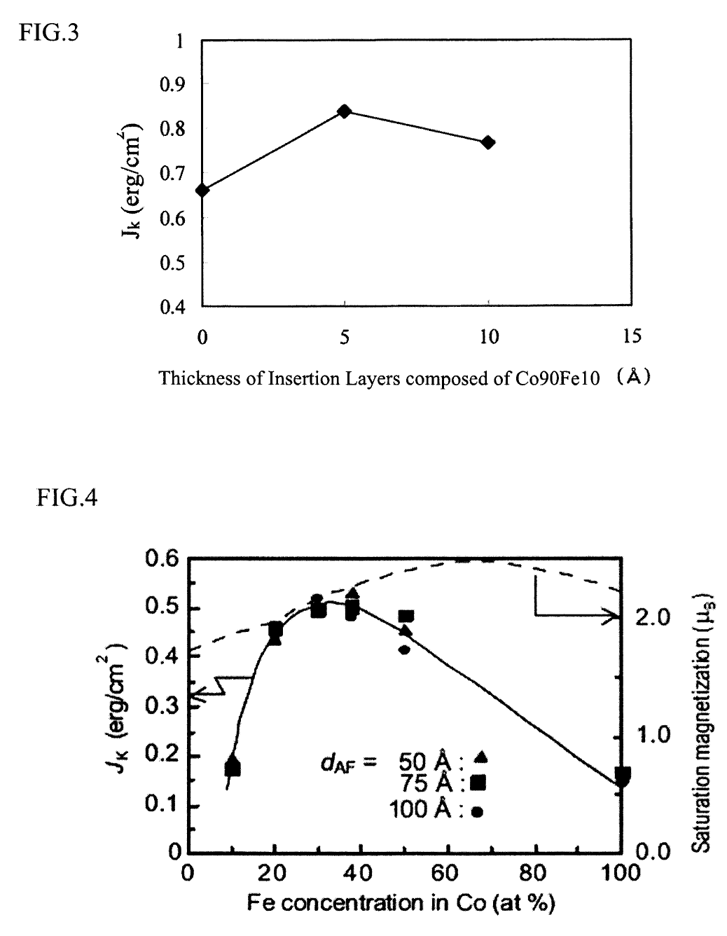

FIG. 3 is a graph of unidirectional anisotropy constants Jk of exchange-coupled elements with respect to thicknesses of insertion layers, wherein each of the exchange-coupled elements includes the antiferromagnetic layer composed of the ordered Mn₃Ir and the insertion layer composed of Co₉₀Fe₁₀. Note that, a sample whose thickness is 0 Å is the conventional exchange-coupled element having no insertion layer composed of Co₉₀Fe₁₀.

According to the graph of FIG. 3, the thickness of the insertion layer should be 10 Å or less, preferably about 5-10 Å.

FIG. 4 is a graph of unidirectional anisotropy constants Jk of exchange-coupled elements, in each of which the antiferromagnetic is composed of the disordered MnIr and the pinned magnetic layer is composed of CoFe. The data are disclosed in “Journal of Magnetism and Magnetic Materials vol. 239 (2002), page 1820-184”. According to the graph of FIG. 3, when concentration of Fe in CoFe is less than 30 at. % or concentration of Co therein is more than 70 at. %, the unidirectional anisotropy constants Jk of exchange-coupled elements are enormously reduced.

FIG. 5 is a graph showing a relationship between compositions of Fe in CoFe alloys and crystal structures in the alloys. The graph indicates that the crystal structure is changed between the face-centered cubic lattice structure (fcc) and the body-centered cubic lattice structures (bcc) at about 20 at. % of Fe.

According to the graph of FIG. 5, we suppose that face-centered cubic lattices gradually formed in body-centered cubic lattices when the concentration of Co in CoFe is about 70 at. % or less and the crystal structure of CoFe is changed from the body-centered cubic lattice structures (bcc) to the face-centered cubic lattice structures (fcc).

On the other hand, according to the graph of FIG. 4, when the concentration of Co in the CoFe alloy is 70 at. % or less, the unidirectional anisotropy constants Jk is drastically reduced. Therefore, we suppose that the crystal structure of the CoFe alloy is changed from the body-centered cubic lattice structures (bcc) to the face-centered cubic lattice structures (fcc) as shown in FIG. 4 when the concentration of Co in the CoFe alloy is about 70 at. % or more, so that the unidirectional anisotropy constants Jk can be drastically reduced.

When the concentration of Co in the CoFe alloy is about 70 at. % or more, if the crystal structure of the body-centered cubic lattice structures (bcc) can be maintained, the unidirectional anisotropy constants Jk can be increased, we suppose.

The results indicate that the unidirectional anisotropy constants Jk greater than that of the conventional film structure can be realized by: forming an antiferromagnetic layer composed of ordered Mn₃Ir; laminating a CoFe layer having the composition, which can have the face-centered cubic lattice structures (fcc), on the antiferromagnetic layer; and laminating a Co₆₅Fe₃₅ layer having the composition, which can have the body-centered cubic lattice structure (bcc), on the CoFe layer. According to the results, we suppose that the upper Co₆₅Fe₃₅ layer having the body-centered cubic lattice structure (bcc) can maintain the body-centered cubic lattice structure (bcc) of the CoFe layer because the CoFe layer, which is laminated on the antiferromagnetic layer and whose composition can have the face-centered cubic lattice structure (fcc), is thin. According to FIG. 3, to maintain the body-centered cubic lattice structure (bcc) of the CoFe layer whose composition can have the face-centered cubic lattice structure (fcc), the thickness of the CoFe layer is about 1 nm or less, we suppose.

In the present specification, “the CoFe layer having the composition, which can have the face-centered cubic lattice structure (fcc)” means that the lower CoFe layer laminated on the antiferromagnetic layer originally have the face-centered cubic lattice structure (fcc), and that, as described above, the lower CoFe layer laminated on the antiferromagnetic layer can have the body-centered cubic lattice structure (bcc) by thinning the lower CoFe layer and laminating the upper CoFe layer having the body-centered cubic lattice structure (bcc) on the lower CoFe layer.

The magnetoresistance effect element 30 shown in FIG. 1 has the above described exchange-coupled element 14, so that the unidirectional anisotropy of the pinned magnetic layer can be improved, read-characteristics can be maintained even if the magnetoresistance effect element 30 is downsized, and the superior magnetoresistance effect element can be produced.

### (Magnetic Storage Apparatus)

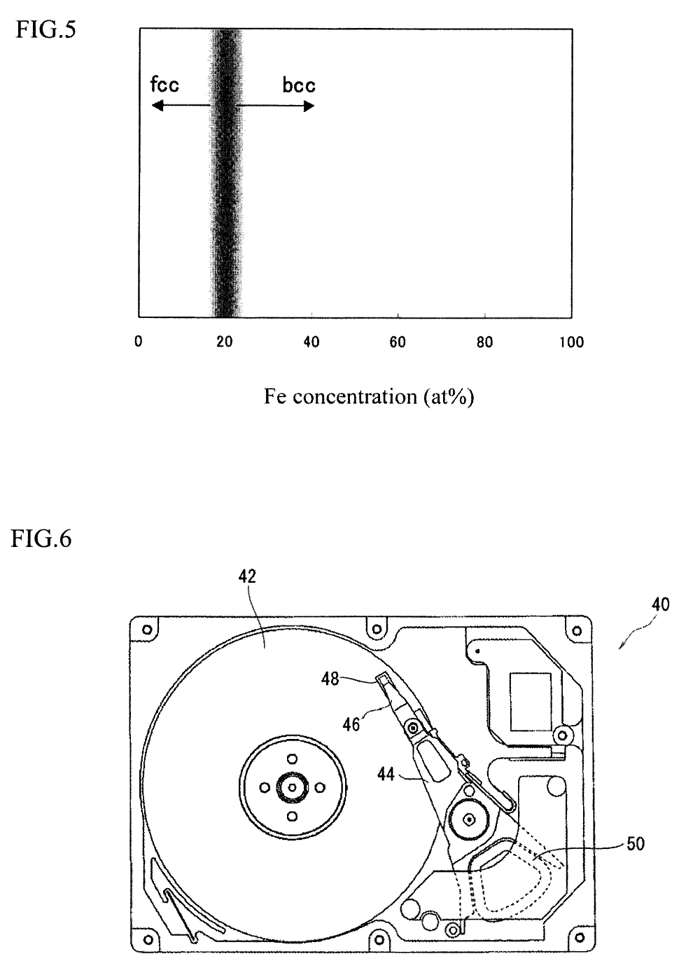

FIG. 6 shows a magnetic storage apparatus 40 having magnetic heads, in each of which the above described magnetoresistance effect element is used.

In the magnetic storage apparatus 40, a plurality of magnetic disks 42 are provided in a rectangular casing and rotated by a spindle motor. Actuator arms 44 are swingably provided in the vicinity of the magnetic disks 42. Head suspensions 46 are respectively provided to front ends of the actuator arms 44 and extended therefrom. Head sliders 48 are respectively provided to front ends of the head suspensions 46. The head sliders 48 are attached to disk-side faces of the head suspension 46.

The magnetic heads having the above described magnetoresistance effect elements are respectively mounted on the head sliders 48.

The magnetic heads are electrically connected to a receiving circuit, which receives electric signals so as to read data recorded in the magnetic disks 42, the receiving circuit being electrically connected to the magnetic heads by cables formed on the head suspensions 46 and provided on the actuator arms 44.

A control section controls a seeking action, in which actuators 50 swings and moves the actuator arms 44 to prescribed positions, so as to write data in and read data from the magnetic disks 42 by the magnetic heads attached to the head sliders 48.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An exchange-coupled element,
comprising:
an ordered antiferromagnetic layer; and
a pinned magnetic layer being exchange-coupled with the ordered antiferromagnetic layer, the pinned magnetic layer having unidirectional magnetization anisotropy,
wherein the pinned magnetic layer is constituted by a first pinned magnetic layer having a composition, which can have a face-centered cubic lattice structure, and a second pinned magnetic layer having a composition, which can have a body-centered cubic lattice structure.

2. The exchange-coupled element according to claim 1,
wherein the first pinned magnetic layer contacts the ordered antiferromagnetic layer, and
the second pinned magnetic layer is laminated on the first pinned magnetic layer.

3. The exchange-coupled element according to claim 1,
wherein the ordered antiferromagnetic layer is composed of Mn₃Ir of L12-type ordered alloy.

4. The exchange-coupled element according to claim 1,
wherein the first pinned magnetic layer is composed of CoₓFe₁₋ₓ (x=1-0.7) and
the second pinned magnetic layer is composed of CoFe, which can have the body-centered cubic lattice structure.

5. The exchange-coupled element according to claim 1,
wherein a thickness of the first pinned magnetic layer is 1 nm or less.

6. A magnetoresistance effect element,
comprising:
an ordered antiferromagnetic layer;
a pinned magnetic layer being exchange-coupled with the ordered antiferromagnetic layer, the pinned magnetic layer having unidirectional magnetization anisotropy;
a free magnetic layer, in which magnetization is rotated by an external magnetic field; and
a nonmagnetic layer being provided between the free magnetic layer and the pinned magnetic layer,
wherein the pinned magnetic layer is constituted by a first pinned magnetic layer having a composition, which can have a face-centered cubic lattice structure, and a second pinned magnetic layer having a composition, which can have a body-centered cubic lattice structure.

7. The magnetoresistance effect element according to claim 6,
wherein the first pinned magnetic layer contacts the ordered antiferromagnetic layer, and
the second pinned magnetic layer is laminated on the first pinned magnetic layer.

8. The magnetoresistance effect element according to claim 6,
wherein the ordered antiferromagnetic layer is composed of an L12-type ordered alloy Mn₃Ir.

9. The magnetoresistance effect element according to claim 6,
wherein the first pinned magnetic layer is composed of CoₓFe₁₋ₓ (x=1-0.7) and
the second pinned magnetic layer is composed of CoFe, which can have the body-centered cubic lattice structure.

10. The magnetoresistance effect element according to claim 6,
wherein a thickness of the first pinned magnetic layer is 1 nm or less.

11. A magnetic storage apparatus,
comprising:
a head slider having a magnetic head for reading data from a recording medium;
a suspension for supporting the head slider over the recording medium;
a turnable actuator arm, to which an end of the suspension is fixed; and
a receiving circuit for receiving electric signals so as to read the data recorded in the recording medium, the receiving circuit being electrically connected to the magnetic head by insulated cables provided on the suspension and the actuator arm,
wherein the magnetic head comprises: an ordered antiferromagnetic layer; a pinned magnetic layer being exchange-coupled with the ordered antiferromagnetic layer, the pinned magnetic layer having unidirectional magnetization anisotropy; a free magnetic layer, in which magnetization is rotated by an external magnetic field; and a nonmagnetic layer being provided between the free magnetic layer and the pinned magnetic layer, and
the pinned magnetic layer is constituted by a first pinned magnetic layer having a composition, which can have a face-centered cubic lattice structure, and a second pinned magnetic layer having a composition, which can have a body-centered cubic lattice structure.

12. The magnetic storage apparatus according to claim 11,
wherein the first pinned magnetic layer contacts the ordered antiferromagnetic layer, and
the second pinned magnetic layer is laminated on the first pinned magnetic layer.

13. The magnetic storage apparatus according to claim 11,
wherein the ordered antiferromagnetic layer is composed of Mn₃Ir of L12-type ordered alloy.

14. The magnetic storage apparatus according to claim 11,
wherein the first pinned magnetic layer is composed of CoₓFe₁₋ₓ (x=1-0.7) and
the second pinned magnetic layer is composed of CoFe, which can have the body-centered cubic lattice structure.

15. The magnetic storage apparatus according to claim 11,
wherein a thickness of the first pinned magnetic layer is 1 nm or less.
